(19) United States
(12) Patent Application Publication
(10) Pub. No.: US 2024/0099192 A1
(43) Pub. Date: Mar. 28, 2024

(54) COMBINE HARVESTER CLEANING SYSTEM WITH FINGER AUGER

(71) Applicant: DEERE & COMPANY, MOLINE, IL (US)

(72) Inventors: YOGESH N. CHANDE, BETTENDORF, IA (US); KEVIN P. HURLEY, DAVENPORT, IA (US); KIRAN KUMAR MAYYA, Pune (IN); MICHAEL T. MESCHKE, ELDRIDGE, IA (US)

(21) Appl. No.: 18/167,243

(22) Filed: Feb. 10, 2023

Related U.S. Application Data
(60) Provisional application No. 63/377,343, filed on Sep. 27, 2022.

(51) Int. Cl. A01D 41/127; A01F 12/44

(52) U.S. Cl. CPC A01D 41/1276; A01F 12/442

(57) ABSTRACT

A cleaning system for use in an agricultural combine harvester comprises a crop-processing platform and a rotatable finger. The crop-processing platform is arranged to receive crop material thereon and reciprocate in a fore-aft manner to process crop material. The finger auger extends laterally in proximity to the crop-processing platform and comprises flighting of fingers arranged to convey crop material laterally upon rotation of the finger auger.

### CROSS-REFERENCE TO RELATED APPLICATIONS

This application claims the benefit of U.S. Provisional Application No. 63/377,343, filed Sep. 27, 2022, the entire contents of which are incorporated herein by reference.

### TECHNICAL FIELD

The present disclosure relates to cleaning systems of agricultural combine harvesters.

### BACKGROUND

Agricultural combine harvesters typically include front-end equipment to gather and transport crop material rearwardly, a feederhouse to advance crop material received from the front-end equipment into the body of the harvester, a threshing and separating system to thresh crop material and separate grain from material other than grain (MOG), a cleaning system to further separate grain from MOG, a clean grain elevator to elevate clean grain to a storage bin, an unloader to offload clean grain from the storage bin, and a residue system to process and distribute crop residue back onto the field. Sidehill operation of the combine harvester can shift lateral distribution of crop material inside the body of the combine harvester.

### SUMMARY

According to an aspect of the present disclosure, there is disclosed a cleaning system for use in an agricultural combine harvester that moves in a forward direction of travel to harvest crop material from a field. The cleaning system comprises a crop-processing platform and a rotatable finger. The crop-processing platform is arranged to receive crop material thereon and reciprocate in a fore-aft manner to process crop material. The finger auger extends laterally in proximity to the crop-processing platform and comprises flighting of fingers arranged to convey crop material laterally upon rotation of the finger auger. Operation of the finger auger can help with sidehill performance of the combine harvester.

The above and other features will become apparent from the following description and accompanying drawings.

### BRIEF DESCRIPTION OF THE DRAWINGS

The detailed description of the drawings refers to the accompanying figures in which:

FIG. 1 a diagrammatic side elevational view, with portions broken away, showing an agricultural combine harvester with various functional systems including a cleaning system underlying a threshing and separating system;

FIG. 2 is a perspective view showing the cleaning system with portions broken away and without a finger auger;

FIG. 3 is a perspective view showing a finger auger included in the cleaning system and positioned at an exit of a front chaffer of the cleaning system and above a floor of a chaffer of the cleaning system;

FIG. 4 is a perspective view showing the finger auger rearward and remote from the front chaffer and above the floor of the chaffer, the finger auger including flighting with full-bay sets of fingers positioned respectively in bays of the chaffer;

FIG. 5 is a perspective view showing the flighting with partial-bay sets of fingers positioned respectively in the bays of the chaffer, the partial-bay sets of fingers having an identical helical sense on opposite sides of the fore-aft centerline, the finger auger sideshifted to a first lateral side of the chaffer (e.g., right side) for rotation in a first direction of rotation;

FIG. 6 is a top plan view showing the flighting with partial-bay sets of fingers positioned respectively in the bays of the chaffer, the partial-bay sets of fingers having the identical helical sense on opposite sides of the fore-aft centerline, the finger auger sideshifted to the first lateral side of the chaffer (e.g., right side) for rotation in the first direction of rotation;

FIG. 7 is a top plan view showing the flighting with partial-bay sets of fingers positioned respectively in the bays of the chaffer, the partial-bay sets of fingers having the identical helical sense on opposite sides of the fore-aft centerline, the finger auger sideshifted to a second lateral side of the chaffer (e.g., left side) for rotation in a second direction of rotation opposite to the first direction of rotation;

FIG. 8 is a top plan view showing the flighting with partial-bay sets of fingers positioned respectively in the bays of the chaffer so as to extend partially across the bays, the partial-bay sets of fingers having opposite helical senses on opposite sides of a fore-aft centerline;

FIG. 9 is a side elevational view showing an area A in which to position a finger auger below the front chaffer near a lower step pan and the chaffer; and

FIG. 10 is a schematic view showing a control system of the combine harvester for controlling the finger auger.

### DETAILED DESCRIPTION

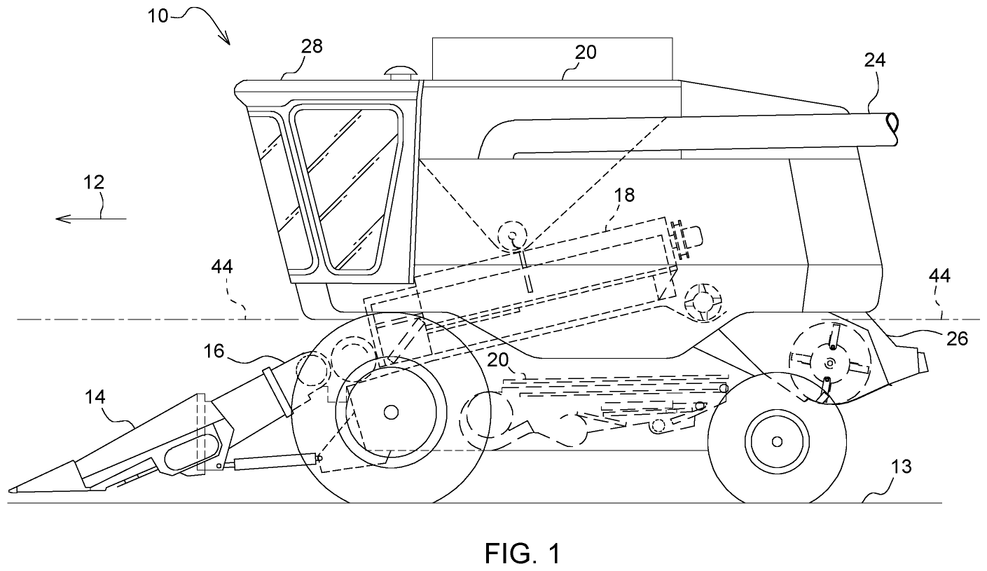

An agricultural combine harvester 10 is configured to move in a forward or harvest direction of travel 12 over a field 13 to harvest crop material from the field 13, as shown, for example, in FIG. 1. The harvester 10 processes the crop, separating grain from residual crop material known as material other than grain or MOG (e.g., straw, stalks, cobs, leaves, chaff).

In general, the harvester 10 may include front-end equipment 14 to cut, gather, and transport crop material rearwardly (some front-end equipment 14 may not cut crop, as in the case of a belt pick-up unit), a feederhouse 16 to advance crop material received from the equipment 14 into the body of the harvester 10, a threshing and separating system 18 to thresh crop material and separate grain from MOG, a cleaning system 20 to separate grain from MOG, a clean grain elevator (not shown) to elevate clean grain to a storage bin 22, an unloader 24 to unload clean grain from the storage bin 22 to another location (e.g., a grain cart), and a residue system 26 to process and distribute crop residue back onto the field. A person can control the harvester 10 from an operator's station 28 of the harvester 10. The harvester 10 may be configured in a wide variety of ways.

The threshing and separating system 18 includes an axial rotor and a concave assembly. The rotor and the concave assembly cooperate to provide the threshing and separating system with a front threshing zone for threshing grain and a rear separating zone for separating threshed grain from MOG. In some examples, the threshing and separating system 18 includes a second rotor (not shown) and a second concave assembly (not shown), which cooperate to provide the threshing and separating system 18 with a second front threshing zone and a second rear separating zone. In such a case, the rotors are similar to one another in structure and function, and the concave assemblies are similar to one another in structure and function. The threshing and separating system 18 may be configured in a wide variety of ways.

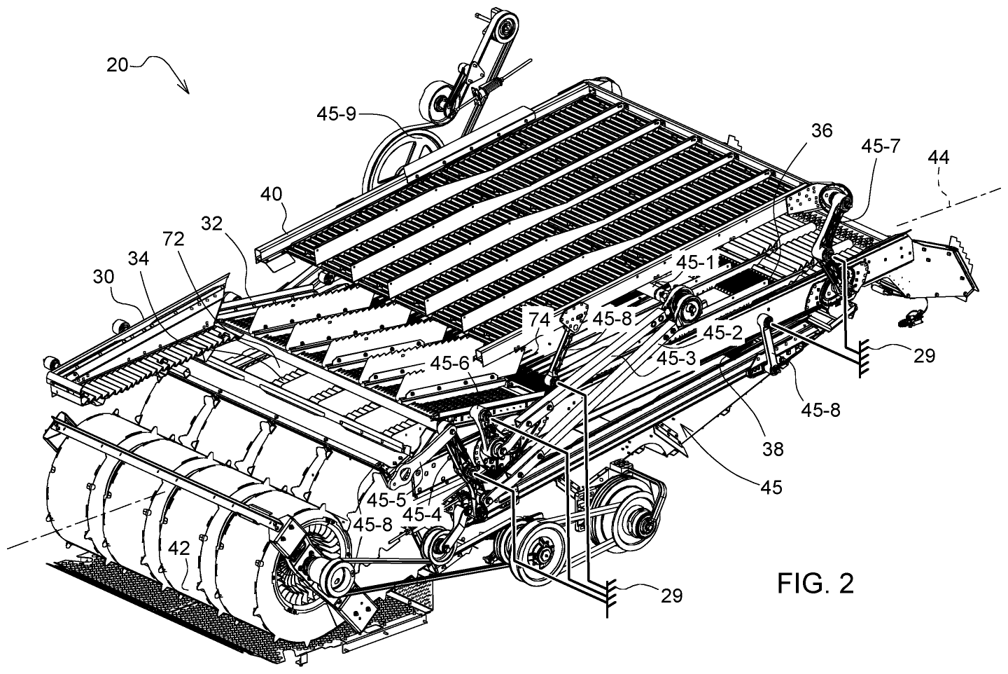

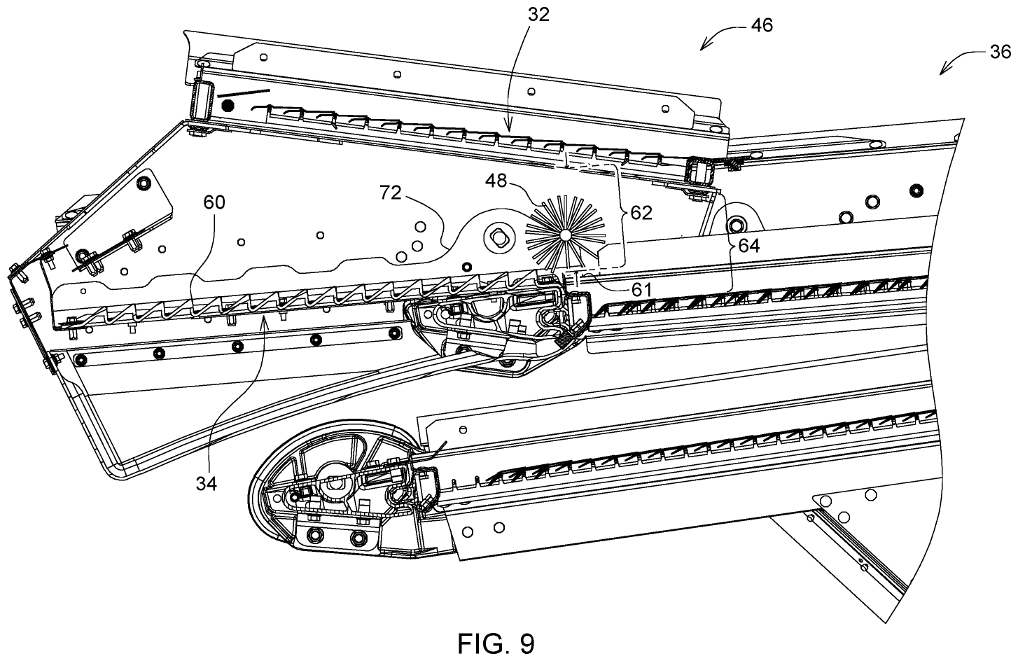

The cleaning system 20, shown, for example, in FIG. 2, may include a front step pan 30 (which may also be referred to as a preparation pan), an inclined front chaffer 32 (which may also be referred to as a sieve), a lower step pan 34 (which may also be referred to as a crash pan) (FIGS. 2 and 9), a chaffer 36 (which may also be referred to as a sieve), a sieve 38, a return pan 40, and a fan assembly 42 (e.g., including four fans). The lower step pan 34 is mounted with the chaffer 36 so as to be positioned in front of the chaffer 36 and below the front chaffer 32. The front step pan 30, the front chaffer 32, the lower step pan 34, the chaffer 36, the sieve 38, and the return pan 40 are arranged for fore-aft reciprocating movement in a fore-aft dimension 44 of the combine harvester 10 to process and advance crop material.

A drive mechanism 45 imparts the fore-aft reciprocating movement. The drive mechanism 45 includes a rotary drive 45-1 and a linkage including a first drive link 45-2, a second drive link 45-3, a front rocker link 45-4, a pan link 45-5, a chaffer link 45-6, a rear rocker link 45-7, and a number of support links 45-8. The linkage is positioned on the left side of the combine harvester 10. The rotary drive 45-1 is rotated by a belt-driven pulley 45-9 positioned on the right side of the combine harvester 10.

The first and second drive links 45-2, 45-3 are coupled eccentrically to the rotary drive 45-1 such that rotation of the rotary drive 45-1 imparts a reciprocating motion to the first and second drive links 45-2, 45-3. The first drive link 45-2 is coupled to the front rocker link 45-4 which is coupled at a first end to the sieve 38 to reciprocate the sieve 38 and at an opposite second end to the pan link 45-5 that reciprocates the front step pan 30 and the front chaffer 32. As such, the sieve 38 reciprocates in a manner opposite to the pan 30 and the front chaffer 32. The second drive link 45-3 is coupled to the chaffer link 45-6 which is coupled to the chaffer 36 to reciprocate the chaffer 36. The rear rocker link 45-7 is coupled at a first end to the chaffer 36 and at an opposite second end to the return pan 40 to reciprocate the return pan 40 in a manner opposite to the chaffer 36 in response to reciprocation of the chaffer 36. The support links 45-8 support the front step pan 30, the front chaffer 32, the lower step pan 34, the chaffer 36, the sieve 38, and the return pan 40 on the support structure 29 (shown diagrammatically) of the combine harvester 10. A similar linkage is positioned on the right side of the combine harvester.

The front step pan 30, the front chaffer 32, the lower step pan 34, and the chaffer 36 reciprocate in phase as a first unit. The sieve 38 and the return pan 40 reciprocate in phase as a second unit. The first and second units reciprocate 180 degrees out of phase with one another. The fore-aft reciprocating movement of the first and second units is relative to the support structure 29. It is to be appreciated that the front step pan 30, the front chaffer 32, the lower step pan 34, the chaffer 36, the sieve 38, and the return pan 40 may be driven for reciprocating movement in any suitable manner.

The front step pan 30 is positioned under a front portion of the threshing and separating system 18 to receive crop material therefrom. Reciprocation of the pan 30 in a fore-aft manner in the fore-aft dimension 44 advances crop material rearwardly toward the front chaffer 32.

The return pan 40 is positioned under a rear portion the threshing and separating system 18 to receive crop material therefrom. Tailings may also be routed back to the return pan 40 for further processing by the cleaning system 20. Reciprocation of the return pan 40 in a fore-aft manner in the fore-aft dimension 44 advances crop material forwardly toward the front chaffer 32.

The front chaffer 32 is arranged to receive crop material thereon and reciprocate in a fore-aft manner in the fore-aft dimension 44 to process crop material. The front chaffer 32 may be referred to as a first chaffer and includes openings in a floor 47 of the front chaffer 32 for grain and smaller MOG to fall through the openings. The front chaffer 32 advances crop material that does not fall through its openings rearwardly toward the chaffer 36.

The lower step pan 34 is positioned under the front step pan 30 to receive crop material therefrom (e.g., grain and smaller MOG). Reciprocation of the lower step pan 34 in a fore-aft manner in the fore-aft dimension 44 advances crop material rearwardly toward the chaffer 36.

The chaffer 36 is arranged to receive crop material thereon and reciprocate in a fore-aft manner in the fore-aft dimension 44 to process crop material. The chaffer 36 may be referred to as a second chaffer and is positioned in proximity to the front chaffer 32 to receive crop material therefrom. The chaffer 36 is positioned lower than, and extends rearwardly away from, the front chaffer 32. The chaffer 36 includes openings in a floor 59 of the chaffer 36 for grain and smaller MOG to fall through the openings. The chaffer 36 advances crop material (mainly MOG) that does not fall through its openings rearwardly.

The sieve 38 is positioned under the chaffer 36 to receive crop material therefrom. The sieve further filters crop material for grain. Reciprocation of the sieve 38 in a fore-aft manner in the fore-aft dimension 44 advances MOG rearwardly.

The fan assembly 42 blows air rearwardly through and across the chaffers 32, 36 and sieve 38 to advance MOG to the residue system 26 for discharge from the combine harvester 10.

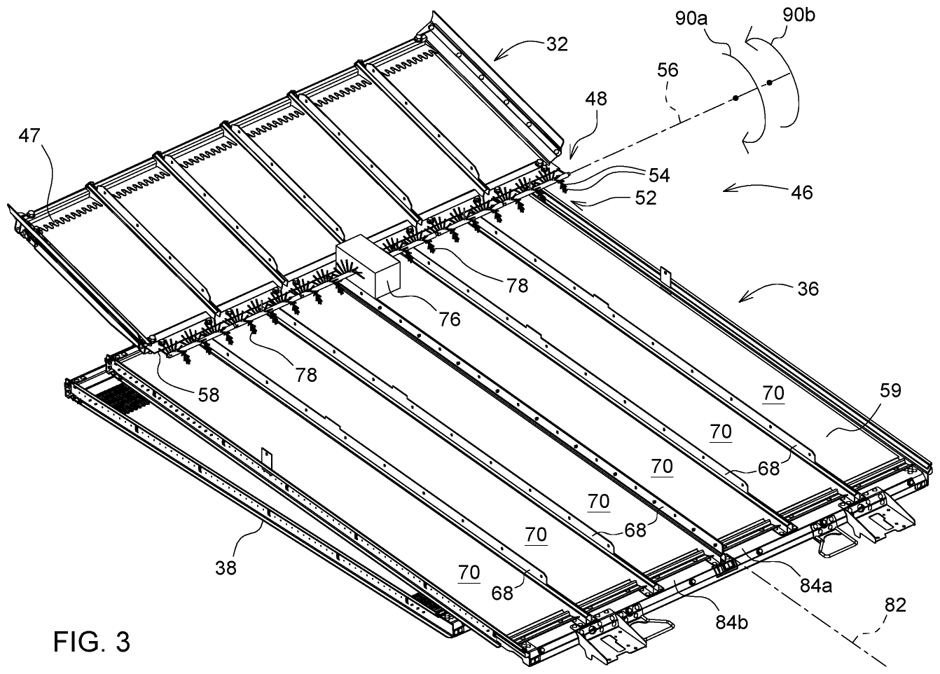

A crop-processing platform 46 of the cleaning system 20 includes the front chaffer 32, the lower step pan 34, and the chaffer 36, as shown, for example, in FIG. 3. The platform 46 is arranged to receive crop material thereon and reciprocate in a fore-aft manner in the fore-aft dimension 44 to process crop material.

The cleaning system 20 includes a rotatable finger auger 48 to enhance the sidehill performance of the cleaning system 20, as shown, for example, in FIGS. 3-8. The finger auger 48 extends laterally in proximity to the crop-processing platform 46 to convey crop material laterally during sidehill operation.

The finger auger 48 includes a rotatable shaft 50 and flighting 52 coupled to the shaft 50. The flighting 52 includes fingers 54 such that the flighting 52 of fingers 54 is arranged to probe and convey crop material laterally upon rotation of the finger auger 48. The fingers 54 act on the mat of crop material, making it more fluidized to help in grain separation and cleaning. The fingers 54 probe into the mat of crop material to help loosen the mat to promote separation of grain from MOG.

The fingers 54 are coupled to and extend radially relative to the shaft 50. The radially inner end of each finger 54 may be fixed directly to the shaft 50 or to one or more sleeves 55 of the flighting 52 surrounding and fixed to the shaft 50 against movement relative thereto so as to rotate therewith. The fingers 54 may be so fixed in a wide variety of ways (e.g., welded, riveted, screwed). The fingers 54 are arranged in a helical pattern about the shaft 50 and about an axis of rotation 56 of the finger auger 48 defined by the shaft 50. As such, the flighting 52 has one or more helical senses.

Each finger 54 may be configured in any suitable manner to engage crop material. The finger 54 may be configured, for example, as a rigid member (e.g., wire, rod) to ply crop material. The finger 54 may take any suitable shape (e.g., straight, curved) with any suitable cross-section (e.g., circular, rectangular, polygonal, oval).

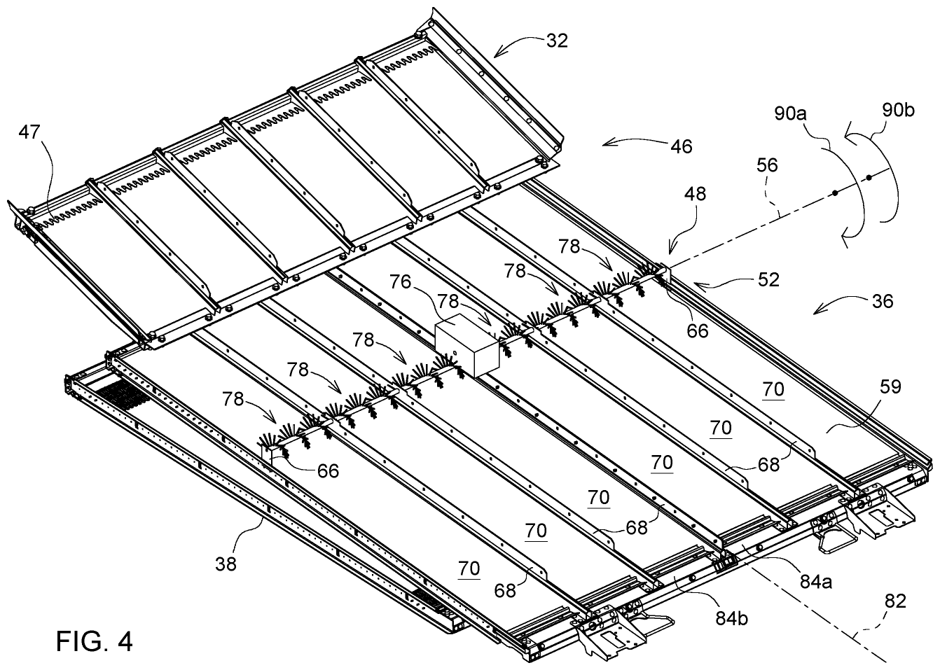

The finger auger 48 may be mounted in any suitable location relative to the crop-processing platform 46. The finger auger 48 may be positioned in proximity to one or both of the front chaffer 32 and the chaffer 36. In some embodiments, shown, for example, in FIG. 3, the finger auger 48 is positioned at an exit 58 of the front chaffer 32 and above a floor 59 of the chaffer 36 in proximity to the chaffers 32, 36 in functional association therewith. In other embodiments, shown, for example, in FIGS. 4-8, the finger auger 48 is positioned rearwardly and remotely from the front chaffer 32 and above the floor 59 of the chaffer 36 in proximity to the chaffer 36 in functional association therewith. In yet other embodiments, shown, for example, in FIG. 9, the finger auger 48 may be positioned below the front chaffer 32 in proximity to and above a floor 60 of the lower step pan 34 and the floor 59 of the chaffer 36 at a junction 61 between the lower step pan 34 and the chaffer 36 therebetween. In such an example, the finger auger 48 is positioned at an exit 62 of the lower step pan 34 and at an entrance 64 of the chaffer 36.

The finger auger 48 may be mounted for rotation about its axis of rotation 56 in a wide variety of ways. The finger auger 48 may be mounted in any suitable manner to the crop-processing platform 46 to reciprocate with the crop-processing platform 46. When the finger auger 48 is positioned at the exit 58 of the front chaffer 32, the finger auger 48 may be mounted to the front chaffer 32 or to the chaffer 36. For example, the finger auger 48 may be rotatably mounted to brackets coupled to the sides of the front chaffer 32 or the chaffer 36. When the finger auger 48 is positioned rearwardly and remotely from the front chaffer 32 and above the floor 59 of the chaffer 36, the finger auger 48 may be mounted to the chaffer 36. The finger auger 48 may be rotatably mounted to brackets 66 coupled to the sides of the chaffer 36, as shown, for example, in FIG. 4. In such a case, the finger auger 48 may extend through or above crop dividers 68 of the chaffer 36 that partition the chaffer 36 into bays 70. Illustratively, the finger auger 48 extends through the crop dividers 68. When the finger auger 48 is positioned below the front chaffer 32 in proximity to the lower step pan 34 and the chaffer 36 and above the floors 59, 60 thereof, the finger auger 48 may be rotatably mounted to brackets (not shown) coupled to the sides of the lower step pan 34, the front chaffer 32, or the chaffer 36 and may extend through crop dividers 72 of the lower step pan 34 and/or the crop dividers 68 of the chaffer 36.

In some embodiments (not shown), the finger auger 48 may be mounted in any suitable manner to the support structure 29 of the combine harvester 10 against reciprocation with the crop-processing platform 46. The finger auger 48 may be mounted to side sheets of the support structure 29. In such a case, a first lateral end of the finger auger 48 is mounted to a first side sheet on one side of the combine harvester 10 and an opposite second lateral end of the finger auger 48 is mounted to a second side sheet on an opposite side of the combine harvester 10.

The cleaning system 20 may or may not include tines with the front chaffer 32. When the finger auger 48 is positioned at the exit 48 of the front chaffer 32, the cleaning system 20 omits such tines. When the finger auger 48 is not positioned at the exit 58 of the front chaffer 32, the cleaning system 20 includes tines 74 that project rearwardly from the front chaffer 32, as shown, for example, in FIG. 2.

The flighting 52 of fingers 54 may be continuous or segmented. In some embodiments (not shown), the flighting 52 of fingers may be continuous for the full length of the finger auger 48, except for mounting of the finger auger 48 at the lateral ends thereof. In such a case, the finger auger 48 may be positioned outside the bays of the platform 46, if any. An actuator (not shown in this embodiment) may be drivingly coupled to a lateral end of the finger auger 48 to rotate the finger auger 48 about the axis of rotation 56.

In other embodiments, the flighting 52 of fingers 54 may be segmented into multiple sets 78 of fingers 54, as shown, for example, in FIGS. 4-8. An actuator 76 (shown diagrammatically) may be drivingly coupled to a laterally central portion of the finger auger 48, as shown, for example, or at a lateral end of the finger auger 48 to rotate the finger auger 48 about the axis of rotation 56.

The flighting 52 may include two sets 78 of fingers, one on either side of the fore-aft centerline 82 of the platform 46, as shown, for example, in FIG. 3, with respect to when the finger auger 48 is positioned at the exit 58 of the front chaffer 32. In such a case, the sets 78 of fingers on a first lateral side 84a of the fore-aft centerline 82 and the sets 78 of fingers on an opposite second lateral side 84b of the fore-aft centerline 82 may have the identical helical sense or opposite helical senses.

In yet other embodiments, the flighting 52 may be segmented into more than two sets 78, as shown, for example, in FIGS. 4-8, when the finger auger 48 is positioned rearwardly and remotely from the front chaffer 32 and above the floor 59 of the chaffer 36. The crop-processing platform 46 may be partitioned laterally into bays. For example, the chaffer 36 is laterally partitioned into bays 70, with bays 70 positioned on the first lateral side 84a of the centerline 82 and bays 70 positioned on the second lateral side 84b of the centerline 82. The sets 78 of fingers are positioned respectively in the bays 70.

Each set 78 of fingers may extend laterally fully across the respective bay 70, as shown, for example, in FIG. 4. In such a case, each set 78 is a full-bay set 78a of fingers. The sets 78 of fingers positioned respectively in the bays 70 on the first lateral side 84a of the centerline 82 and the sets 78 of fingers positioned respectively in the bays 70 on the second lateral side 84b of the centerline 82 may have the identical helical sense. In other embodiments, they may have opposite helical senses.

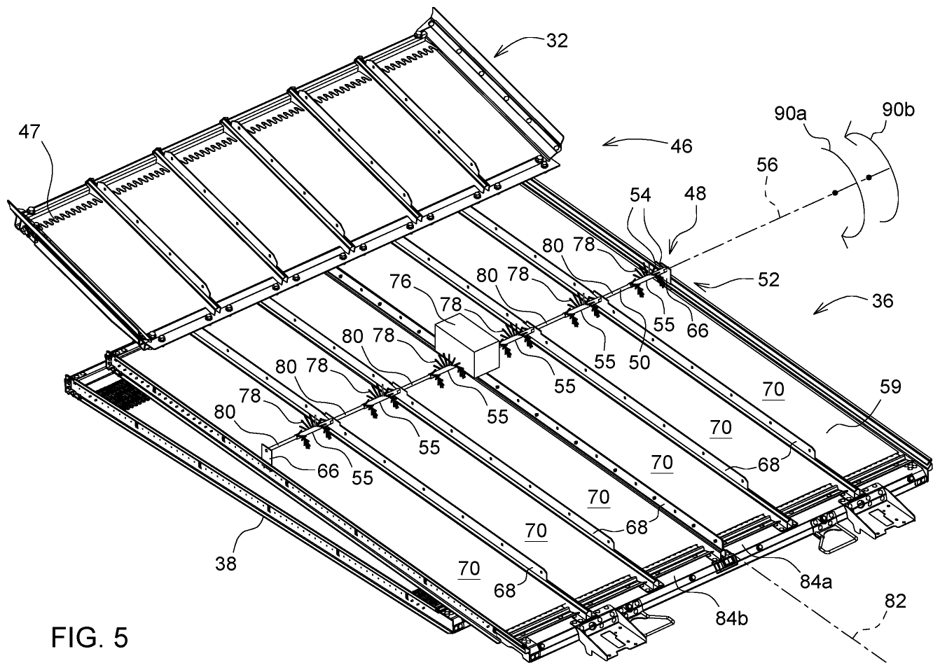

Each set 78 of fingers may extend only partially across the respective bay 70, as shown, for example, in FIGS. 5-8. In such a case, each set 78 is a partial-bay set 78 of fingers. Since the set 78 of fingers extends only partially across the bay 70, the finger auger 48 includes a fingerless section 80 positioned in each respective bay 70 for crop material to pass around the finger auger 48 and avoid clogging and plugging. The fingerless section 80 is fingerless in the sense that it lacks any fingers 54. The set 78 of fingers shifts crop material toward the fingerless section 80, while other crop material may pass the finger auger 48 through the fingerless section 80 without engagement by the set 78 of fingers.

In some partial-bay embodiments, shown, for example, in FIGS. 5-7, each set 78 of fingers positioned in a respective bay 70 on the first lateral side 84a of the centerline 82 is positioned on a given lateral side 86a or 86b of that bay 70, and each set 78 of fingers positioned in a respective bay 70 on the opposite second lateral side 84b of the centerline 82 is positioned on the identical lateral side 86a or 86b of that bay 70. The sets 78 of fingers on the first and second lateral sides 84a, 84b of the centerline 82 may have the identical helical sense.

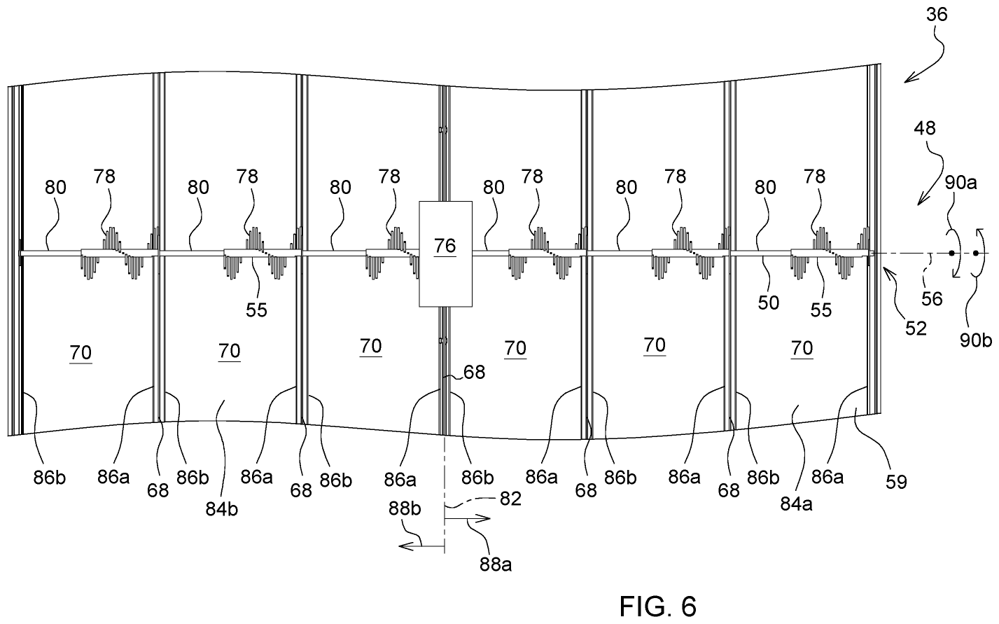

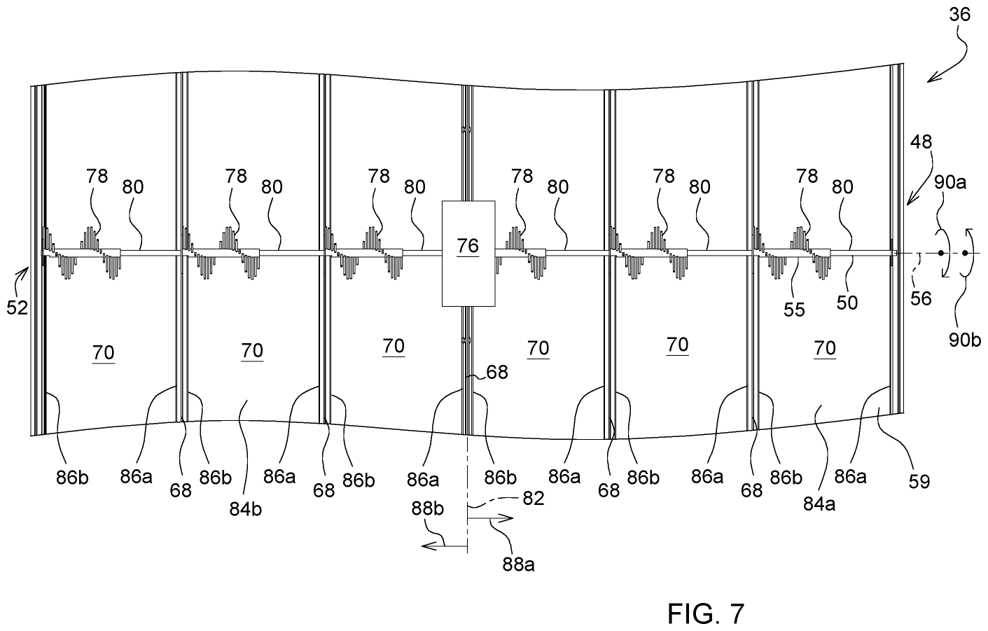

The finger auger 48 may be configured to be laterally sideshifted to move the finger auger 48 in first and second laterally opposite directions 88a, 88b relative to the platform 46 between a first lateral position and a second lateral position. In the first lateral position, shown, for example, in FIGS. 5 and 6, the sets 78 of fingers on both lateral sides 84a, 84b of the centerline 82 are positioned respectively on the first lateral side 86a of the bays 70. In the second lateral position, shown, for example, in FIG. 7, the sets 78 of fingers on both lateral sides 84a, 84b of the centerline 82 are positioned respectively on the second lateral side 86b of the bays 70. The actuator 76 may be coupled to the central portion of the finger auger 48 to sideshift the finger auger 48.

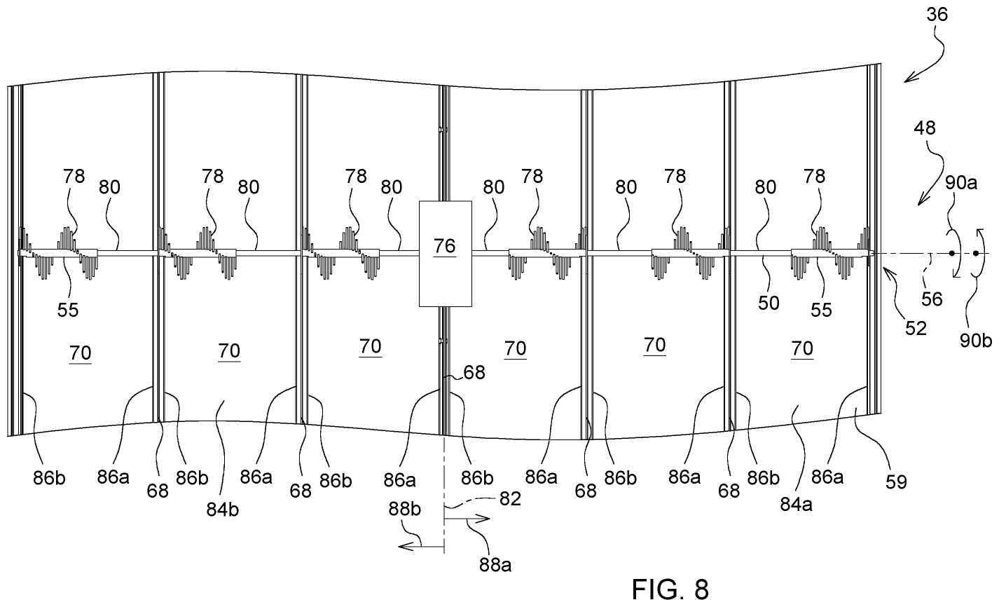

In some partial-bay embodiments, shown, for example, in FIG. 8, each set 78 of fingers positioned in a respective bay 70 on the first lateral side 84a of the centerline 82 is positioned on the first lateral side 86a of that bay 70, and each set 78 of fingers positioned in a respective bay 70 on the opposite second lateral side 84b of the centerline 82 is positioned on the opposite second lateral side 86b of that bay 70. The sets 78 of fingers on the first lateral side 84a of the centerline 82 have a first helical sense, and the sets 78 of fingers on the second lateral side 84b of the centerline 82 have an opposite second helical sense.

As alluded to herein, the flighting 52 may have one or more sleeves 55 disposed about the shaft 50 and to which the fingers 54 are mounted. In some embodiments, the flighting 52 may have a single sleeve 55 extending substantially the full length of the shaft 50. In other embodiments, the flighting 52 may have two sleeves 55 each extending substantially half the length of the shaft 50, with the actuator 76 coupled to the central portion of the finger auger 48 therebetween. In yet other embodiments, shown, the flighting 52 may have multiple sleeves 55 each positioned in a respective bay of the platform 46 (e.g., bay 70 of chaffer 36 and/or a bay of the lower step pan 34) and associated with a respective set 78 of fingers mounted thereto. Each sleeve 55 may be positioned outside the crop dividers 68, 72, may extend through one or more crop dividers 68, 72, or may be positioned in a respective bay without extending through any crop dividers 68, 72.

The actuator 76 may be configured in a wide variety of ways to rotate the finger auger 48 about the axis of rotation 56. For example, the actuator 76 includes a motor (e.g., electric, hydraulic, pneumatic). A motor shaft of the motor is coupled to the finger auger 48 via a mechanism of the actuator 76. The mechanism may be configured, for example, as a gear mechanism, a belt-and-pulley mechanism, a direct connection between the motor shaft and an end of the shaft 50, or other suitable mechanism.

The actuator 76 may be configured to rotate the finger auger 48 in a single direction about the axis 56 or in opposite directions about the axis 56. If the flighting 52 has a single helical sense, the actuator 76 is configured to rotate the finger auger 48 in a first direction of rotation 90a about the axis 56 and an opposite second direction of rotation 90b about the axis 56, as shown, for example, in FIGS. 5-7. If the flighting 52 has opposite helical senses, e.g., a first helical sense on the first lateral side 84a of the centerline 82 and an opposite second helical sense on the second lateral side 84b of the centerline 82, as shown, for example, in FIG. 8, the actuator 76 is configured to rotate the finger auger 48 in a single direction about the axis 56.

The actuator 76 may be coupled to the finger auger 48 at any suitable location to rotate the finger auger 48 about the axis of rotation 56. In some embodiments (not shown), the actuator 76 is coupled to an end of the finger 48. In such a case, the actuator 76 may be positioned outside the side sheets of the of the support structure 29. In other embodiments, shown, for example, in FIGS. 3-8, the actuator 76 is positioned inside the side sheets in a cleaning chamber of the combine harvester 10 and coupled to the central portion of the finger auger 48.

In the case where the finger auger 48 can be sideshifted, shown, for example, in FIGS. 5-7, the actuator 76 may be configured in a wide variety of ways to sideshift the finger auger 48 in the first lateral direction 88a and the opposite second lateral direction 88b. For example, the actuator 76 may include a rack-and-pinion mechanism, a belt-and-pulley mechanism, a double-acting cylinder, or other suitable mechanism to sideshift the finger auger 48. A pinion of the rack-and-pinion mechanism or a pulley of the belt-and-pulley mechanism may be rotated as appropriate to sideshift the finger auger 48 in the respective lateral direction 88a, 88b. The actuator 76 may include a second motor or other mechanism with an input shaft to rotate the pinion or pulley.

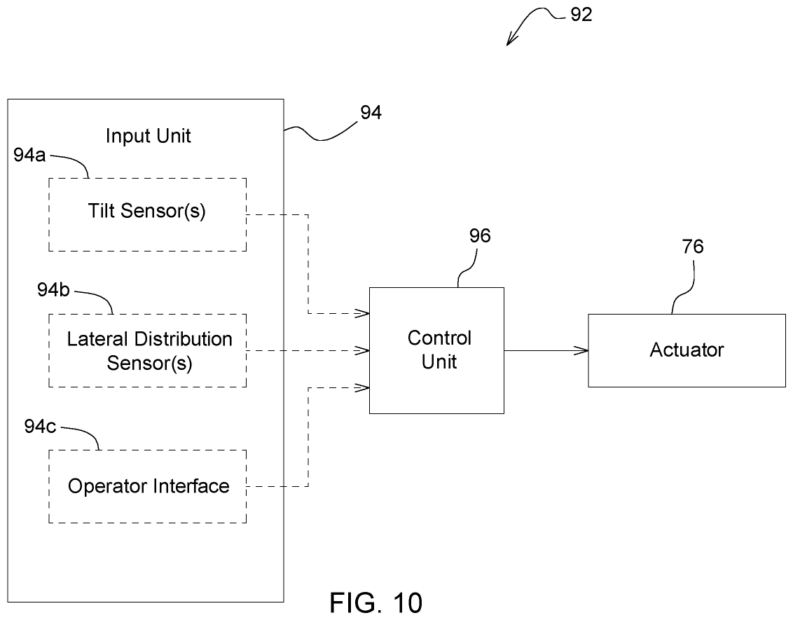

Various operational parameters of the finger auger 48 are under the control of a control system 92, shown, for example, in FIG. 10. For example, the control system 92 is configured to control speed of rotation of the finger auger 48, the direction of rotation of the finger auger 48 if the flighting 52 has opposite helical senses on opposite sides 84a, 84b of the fore-aft centerline 82, and/or the direction of sideshifting of the finger auger 48 if the flighting 52 has the same helical sense on both sides 84a, 84b of the fore-after centerline 82 and the finger auger 48 is sideshiftable. The control system 92 is configured to control such operational parameters based on a sensorially detected tilt (lateral inclination) of the combine harvester 10 and/or a sensorially detected lateral distribution of crop material over the width of the cleaning system 20 and/or an operator input via a suitable operator interface.

The control system 92 may include an input unit 94. In some embodiments, the input unit 94 may include one or more sensors 94a configured to detect tilt of the combine harvester 10, such as when the combine harvester 10 is operating on a slope, and to generate one or more signals indicative of tilt. For example, the input unit 94 may include an inclinometer to so detect tilt and generate a tilt signal. In other embodiments, the input unit 94 may include one or more sensors 94b configured to detect lateral distribution of crop material over the width of the cleaning system 20, due, for example, to tilt of the combine harvester 10, and to generate one or more signals indicative of such lateral distribution. In yet other embodiments, the input unit 94 may include an operator interface 94c. In an example, an operator (a person operating the combine harvester 10) may provide a manual input indicative of the tilt of the combine harvester 10 via the interface 94c. The interface 94c may then generate a signal indicative of such operator input and combine harvester tilt. The input unit 94 may include any one or more of the sensor(s) 94a, the sensor(s) 94b, or the interface 94c.

The control system 92 includes a control unit 96. The control unit 96 is configured to receive signals from the input unit 94 and to output control signals to the actuator 76 to control the applicable operational parameters of the finger auger 48. The control unit 96 includes one or more controllers, each including a processor and memory with instructions stored therein, which, when executed by the processor, causes the processor to execute the functions of the respective controller.

The control unit 96 may be configured to output a control signal to cause the actuator 76 to change the speed of rotation of the finger auger 48 based on one or more signals from the input unit 94. The control unit 96 may be configured to output a control signal to cause the actuator 76 to increase the speed of rotation of the finger auger 48 based on a signal from a tilt sensor 94a indicating an increase in an angle of tilt of the combine harvester 10 and to decrease the speed of rotation of the finger auger 48 based on a signal from a tilt sensor 94a indicating a decrease in the angle of tilt of the combine harvester 10. As such, the actuator 76 is operable to increase the speed of rotation of the finger auger 48 when an angle of tilt of the platform 46 is increased and to decrease the speed of rotation of the finger auger 48 when an angle of tilt of the platform 46 is decreased.

The control unit 94 may be configured to output a control signal to cause the actuator 76 to change the direction of rotation of the finger auger 48 based on one or more signals from the input unit 94. Such rotational direction change would apply if the flighting 52 has the same helical sense. The control unit 96 may configured to output a control signal to cause the actuator 76 to rotate the finger auger 48 in the first direction of rotation 90a about the axis 56 based on a signal from a tilt sensor 94a indicating that the combine harvester 10 is tilted to the first lateral side 84a and to rotate the finger auger 48 in the second direction of rotation 90b about the axis 56 based on a signal from a tilt sensor 94a indicating that the combine harvester 10 is tilted in a second tilt to the second lateral side 84b. As such, the actuator 76 is operable to rotate the finger auger 48 in the first direction of rotation 90a when the platform 46 is tilted in a first direction of tilt and in a second direction of rotation 90b opposite to the first direction of rotation 90a when the platform 46 is tilted laterally in a second direction of tilt opposite to the first direction of tilt.

The control unit 96 may be configured to output a control signal to cause the actuator 76 to sideshift the finger auger 48 to the downhill side of the combine harvester 10 based on one or more signals from the input unit 94. The control unit 96 may be configured to output a control signal to cause the actuator 76 to sideshift the finger auger 48 in the first lateral direction 88a to a first lateral position (FIGS. 5 and 6) based on a signal from a tilt sensor 94a indicating that the combine harvester 10 is tilted to the first lateral side 84a and to sideshift the finger auger 48 in the second lateral direction 88b to a second lateral position (FIG. 7) based on a signal from a tilt sensor 94a indicating that the combine harvester 10 is tilted to the second lateral side 84b. As such, the actuator 76 is operable to sideshift the finger auger 48 in the first lateral direction 88a when the platform 46 is tilted to the first lateral side 84a and in the second lateral direction 88b when the platform 46 is tilted to the second lateral side 84b.

While the above describes example embodiments of the present disclosure, these descriptions should not be viewed in a limiting sense. Rather, other variations and modifications can be made without departing from the scope and spirit of the present disclosure as defined in the appended claims.

What is claimed is:

1. A cleaning system for use in an agricultural combine harvester that moves in a forward direction of travel to harvest crop material from a field, the cleaning system comprising:
a crop-processing platform arranged to receive crop material thereon and reciprocate in a fore-aft manner to process crop material, and
a rotatable finger auger extending laterally in proximity to the crop-processing platform and comprising flighting of fingers arranged to convey crop material laterally upon rotation of the finger auger.

2. The cleaning system of claim 1, wherein the finger auger comprises a rotatable shaft, and the fingers are coupled to and extend radially relative to the shaft.

3. The cleaning system of claim 1, wherein the finger auger is mounted to the crop-processing platform to reciprocate therewith.

4. The cleaning system of claim 1, wherein the finger auger is mounted to a support structure of the agricultural combine harvester against reciprocation with the crop-processing platform.

5. The cleaning system of claim 1, wherein the crop-processing platform comprises a chaffer, and the finger auger is positioned in proximity to the chaffer.

6. The cleaning system of claim 5, wherein the finger auger is positioned at an exit of the chaffer.

7. The cleaning system of claim 5, wherein the finger auger is positioned above a floor of the chaffer.

8. The cleaning system of claim 5, wherein the chaffer is a first chaffer, the crop-processing platform comprises a second chaffer positioned in proximity to the first chaffer to receive crop material therefrom and extending rearwardly away from the first chaffer, and the finger auger is positioned above a floor of the second chaffer.

9. The cleaning system of claim 8, wherein the finger auger is positioned at an exit of the first chaffer.

10. The cleaning system of claim 1, wherein the crop-processing platform is partitioned laterally into bays, and the flighting of fingers comprise sets of fingers positioned respectively in the bays.

11. The cleaning system of claim 10, wherein each set of fingers extends laterally fully across the respective bay.

12. The cleaning system of claim 10, wherein each set of fingers extends laterally only partially across the respective bay.

13. The cleaning system of claim 12, wherein the bays comprise a first bay and a second bay, the first and second bays are positioned on laterally opposite sides of a fore-aft centerline of the crop-processing platform, the sets of fingers comprise a first set of fingers positioned in the first bay and a second set of fingers positioned in the second bay, and the first and second sets of fingers are positioned respectively on laterally opposite sides of the first and second bays.

14. The cleaning system of claim 12, wherein the bays comprise a first bay and a second bay, the first and second bays are positioned on laterally opposite sides of a fore-aft centerline of the crop-processing platform, the sets of fingers comprise a first set of fingers positioned in the first bay and a second set of fingers positioned in the second bay, and the first and second sets of fingers are positioned respectively on laterally identical sides of the first and second bays.

15. The cleaning system of claim 10, wherein the sets of fingers comprise a first set of fingers having a first helical sense and a second set of fingers having an opposite second helical sense.

16. The cleaning system of claim 10, wherein the sets of fingers comprise a first set of fingers having a first helical sense and a second set of fingers having an identical second helical sense.

17. The cleaning system of claim 1, comprising an actuator operable to laterally side-shift the finger auger.

18. The cleaning system of claim 1, comprising an actuator operable to rotate the finger auger in opposite directions.
